(19) United States
(12) Patent Application Publication
(10) Pub. No.: US 2026/0074454 A1
(43) Pub. Date: Mar. 12, 2026

(54) CONNECTOR AND ELECTRONIC DEVICE

(71) Applicant: Samsung Display Co., Ltd., Yongin-si (KR)

(72) Inventors: Se Young LEE, Yongin-si (KR); Jong Min SHIM, Yongin-si (KR); Min Soo CHOI, Yongin-si (KR)

(21) Appl. No.: 19/188,479

(22) Filed: Apr. 24, 2025

(30) Foreign Application Priority Data
Sep. 12, 2024 (KR) 10-2024-0125113

(51) Int. Cl. H01R 13/04; G06F 1/18; H01R 12/70; H01R 12/77; H04M 1/02

(52) U.S. Cl. CPC H01R 13/04; G06F 1/183; H01R 12/7076; H04M 1/0266; H01R 12/77

(57) ABSTRACT

A connector including a case, first pins, each having a first coupling portion coupled to the case and a first contact portion protruding from the first coupling portion, and second pins, each having a second coupling portion coupled to the case and a second contact portion protruding from the second coupling portion. A height of the first contact portion is different from a height of the second contact portion.

### CROSS-REFERENCE TO RELATED APPLICATION

The present application claims priority to and the benefit of Korean Patent Application No. 10-2024-0125113, filed on Sep. 12, 2024, in the Korean Intellectual Property Office, the entire disclosure of which is incorporated herein by reference.

### BACKGROUND

### 1. Field

Aspects of embodiments of the present disclosure relate to a connector, a display device, and an electronic device.

### 2. Description of the Related Art

Because interest in information displays has recently increased, research and development into a display device is being continuously conducted.

### SUMMARY

Embodiments of the present disclosure provide a connector exhibiting an improved bending phenomenon and a display device including the same.

Aspects and features of the present disclosure are not limited to those described above, and other aspects and features that are not expressly described will be clearly understood by those skilled in the art from the description below.

According to an embodiment of the present disclosure, a connector includes a case, first pins, and second pins. Each of the first pins has a first coupling portion coupled to the case and a first contact portion protruding from the first coupling portion, and each of the second pins has a second coupling portion coupled to the case and a second contact portion protruding from the second coupling portion. A height of the first contact portion is different from a height of the second contact portion.

The height of the first contact portion may be higher than the height of the second contact portion.

A height difference between the first contact portion and the second contact portion may be 80 μm or less.

A width of the first contact portion may be greater than a width of the second contact portion.

A width of the first coupling portion may be greater than a width of the second coupling portion.

The second pins may be between adjacent ones of the first pins.

The first pins may be at an outer side of the connector.

The second pins may be at a center of the connector.

According to an embodiment of the present disclosure, a connector includes a case, first pins, and second pins. Each of the first pins has a first coupling portion coupled to the case and a first contact portion protruding from the first coupling portion, and each of the second pins has a second coupling portion coupled to the case and a second contact portion protruding from the second coupling portion. A number of the first contact portions is different from a number of the second contact portions.

The number of the first contact portions may be greater than the number of the second contact portions.

An area of the first contact portion may be greater than an area of the second contact portion.

A width of the first coupling portion may be greater than a width of the second coupling portion.

The second pins may be between adjacent ones of the first pins.

The first pins may be at an outer side of the connector.

The second pins may be at a center of the connector.

According to an embodiment of the present disclosure, a display device includes a display panel, a circuit board electrically connected to the display panel, and a connector. The connector includes a case, first pins, and second pins. The first pins and the second pins are electrically connected to the circuit board. Each of the first pins has a first coupling portion coupled to the case and a first contact portion protruding from the first coupling portion, and each of the second pins has a second coupling portion coupled to the case and a second contact portion protruding from the second coupling portion. A height of the first contact portion is different from a height of the second contact portion.

The height of the first contact portion may be higher than the height of the second contact portion.

The circuit board may include a first pad electrically connected to the first contact portion, and a second pad electrically connected to the second contact portion.

A width of the first pad may be greater than a width of the second pad.

A distance between the first pad and the first contact portion may be greater than a distance between the second pad and the second contact portion.

According to an embodiment of the present disclosure, an electronic device includes a processor configured to provide input image data and a display device configured to display an image based on the input image data. The display device includes a display panel, a circuit board electrically connected to the display panel, and a connector. The connector includes a case, first pins, and second pins. The first pins and the second pins are electrically connected to the circuit board. Each of the first pins has a first coupling portion coupled to the case and a first contact portion protruding from the first coupling portion, and each of the second pins has a second coupling portion coupled to the case and a second contact portion protruding from the second coupling portion. A height of the first contact portion is different from a height of the second contact portion.

Aspects, features, and details of other embodiments are included in the detailed description and drawings.

According to embodiments of the present disclosure, even if a solder thickness step occurs due to a pad size difference between the first pin and the second pin of the connector, the connector is not bent by adjusting the height (or a length) of the first pin.

Aspects and features according to embodiments are not limited to the those above, and further various aspects and features are included in the present specification.

### BRIEF DESCRIPTION OF THE DRAWINGS

The above and other aspects and features of the present disclosure will become more apparent by describing, in further detail, embodiments thereof with reference to the accompanying drawings, in which:

FIG. 1 is a perspective view of a display device according to an embodiment;

FIG. 2 is a side view of a display device according to an embodiment;

FIG. 3 is a perspective view of a connector according to an embodiment;

FIG. 4 is an exploded perspective view of a connector according to an embodiment;

FIG. 5 is a rear view of a connector according to an embodiment;

FIG. 6 is a perspective view of a first pin according to an embodiment;

FIG. 7 is a perspective view of a second pin according to an embodiment;

FIGS. 8 to 11 are side views of a first pin and a second pin according to an embodiment;

FIG. 12 is a plan view of a display panel according to an embodiment;

FIG. 13 is a plan view of a sub-pixel according to an embodiment; and

FIG. 14 is a cross-sectional view taken along the line I-I′ in FIG. 13.

FIG. 15 is a block diagram describing an electronic device according to an embodiment.

FIG. 16 shows schematic views of various embodiments of an electronic device.

### DETAILED DESCRIPTION

Hereinafter, embodiments of the present disclosure are described, in detail, with reference to the accompanying drawings. It is noted that in the following description, only portions necessary for understanding an operation according to the present disclosure are described, and descriptions of other portions may be omitted or only briefly described so as to not obscure the subject matter of the present disclosure. In addition, the present disclosure may be embodied in other forms and is not limited to the embodiment described herein. The embodiments described herein provide sufficient for those skilled in the art to easily implement the technical spirit of the present disclosure.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

Various embodiments are described with reference to drawings schematically illustrating ideal embodiments. Accordingly, it will be expected that shapes may vary, for example, according to tolerances and/or manufacturing techniques. Therefore, the embodiments disclosed herein should not be construed as being limited to shown specific shapes and should be interpreted as including, for example, changes in shapes that occur as a result of manufacturing. As described above, the shapes shown in the drawings may not show actual shapes of areas of a device, and the present embodiments are not limited thereto.

Hereinafter, embodiments of the present disclosure are described in detail with reference to the attached drawings.

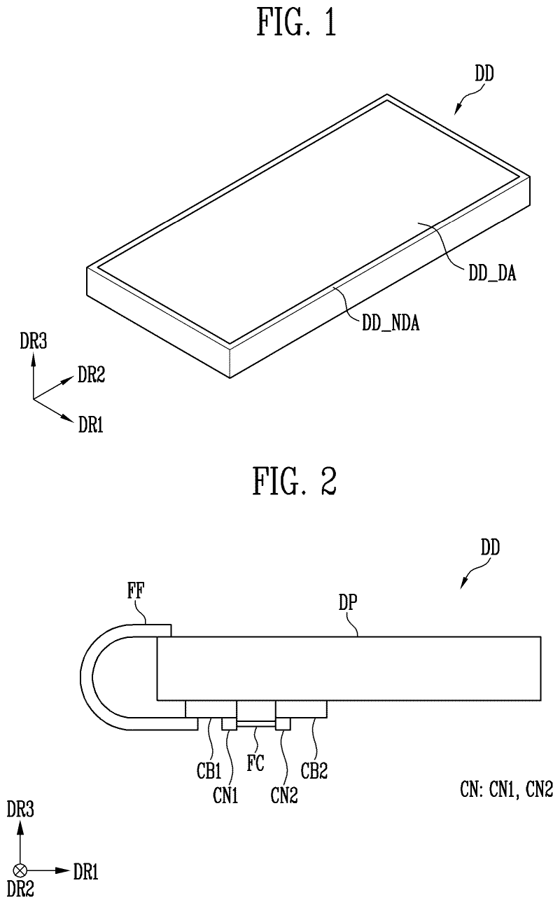

FIG. 1 is a perspective view of a display device according to an embodiment. FIG. 2 is a side view of a display device according to an embodiment.

Referring to FIGS. 1 and 2, the display device DD may have a display area DD_DA at where an image is displayed and a non-display area DD_NDA where no image is displayed. The non-display area DD_NDA may be provided on at least one side of the display area DD_DA. For example, the non-display area DD_NDA may be provided to surround (e.g., to extend around a periphery of) an edge of the display area DD_DA.

The display device DD may have various shapes. The display device DD may have a closed loop shape including sides having a straight line shape and/or a curved line shape. For example, the display device DD may have various shapes, such as a polygon, a circle, a semicircle, and an ellipse.

The display device DD may be applied to an electronic device having an image display function, such as a portable computer, a mobile phone, a smart phone, a tablet personal computer (PC), a smart watch, and a navigation device. In addition, the display device DD may be applied to an electronic device to which a display surface is applied to at least one surface, such as a head mounted display (HMD), a virtual reality (VR) device, a mixed reality (MR) device, and an augmented reality (AR) device.

In an embodiment, the display device DD may have a flat display surface. In another embodiment, the display device DD may have an at least partially rounded display surface. In an embodiment, the display device DD may be bendable, foldable, or rollable. In such embodiments, the display device DD may include materials having a flexible property.

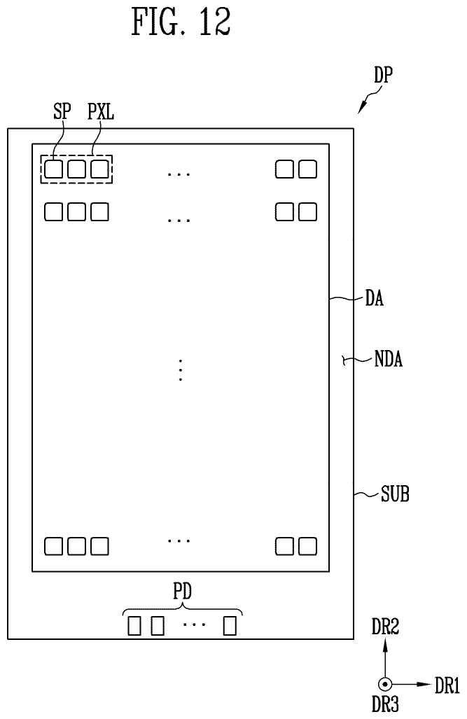

The display device DD may include a display panel DP. The display panel DP may be implemented as an organic light emitting display panel (OLED panel) that uses an organic light emitting diode as a light emitting element, an ultra-small light emitting diode display panel (micro-LED or nano-LED display panel) that uses an ultra-small light emitting diode as a light emitting element, a quantum dot organic light emitting display panel (QD OLED panel) that uses a quantum dot and an organic light emitting diode, or the like, but is not limited thereto. A detailed description of the display panel DP is described below with reference to FIGS. 12 to 14.

One end of a flexible film FF may be electrically connected to the display panel DP, and another end of the flexible film FF may be electrically connected to a first circuit board CB1. The flexible film FF may be implemented as a chip on film (COF) on which a driver integrated circuit is mounted but is not limited thereto. The display panel DP may receive voltages and signals for (e.g., to enable) panel operation through the flexible film FF.

The first circuit board CB1 may be disposed under the display panel DP. The first circuit board CB1 may be fixed to a rear surface of the display panel DP. One side of the first circuit board CB1 may be electrically connected to the flexible film FF, and another side of the first circuit board CB1 may be electrically connected to a first connector CN1.

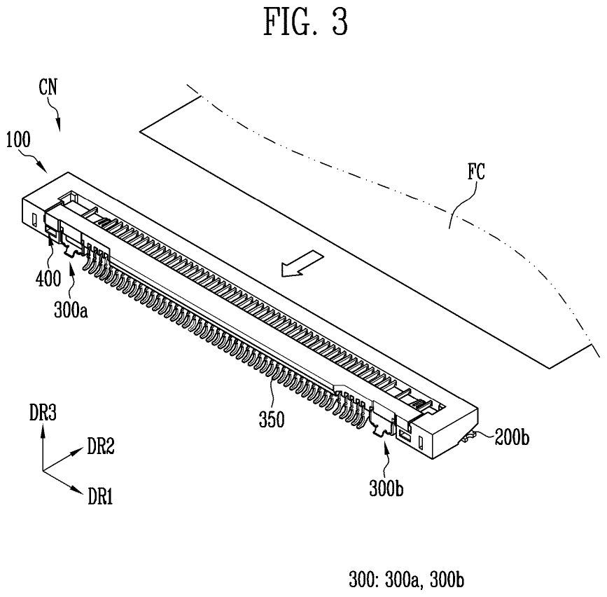

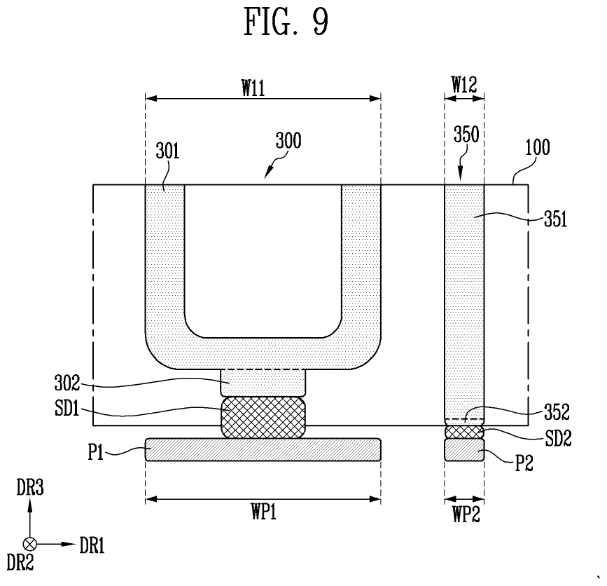

The first connector CN1 may be disposed under the display panel DP. One side of the first connector CN1 may be electrically connected to the first circuit board CB1, and another side of the first connector CN1 may be electrically connected to a flexible cable FC. The first connector CN1 may be a connector for a flexible cable mounted on a surface of a circuit board. A detailed description of the first connector CN1 is described below with reference to FIGS. 3 to 11.

One end of the flexible cable FC may be electrically connected to the first connector CN1, and another end of the flexible cable FC may be electrically connected to a second connector CN2. The flexible cable FC may be a flexible flat cable (FFC) but is not limited thereto.

The second connector CN2 may be disposed under the display panel DP. One side of the second connector CN2 may be electrically connected to the flexible cable FC, and another side of the second connector CN2 may be electrically connected to a second circuit board CB2. The second connector CN2 may be a connector for a flexible cable mounted on a surface of a circuit board. A detailed description of the second connector CN2 is described below with reference to FIGS. 3 to 11. The second circuit board CB2 may be disposed under the display panel DP. The second circuit board CB2 may be fixed to the rear surface of the display panel DP.

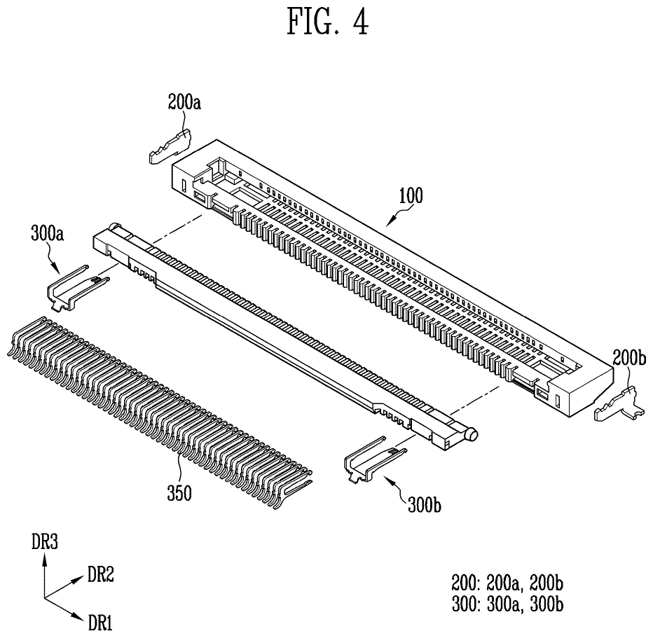

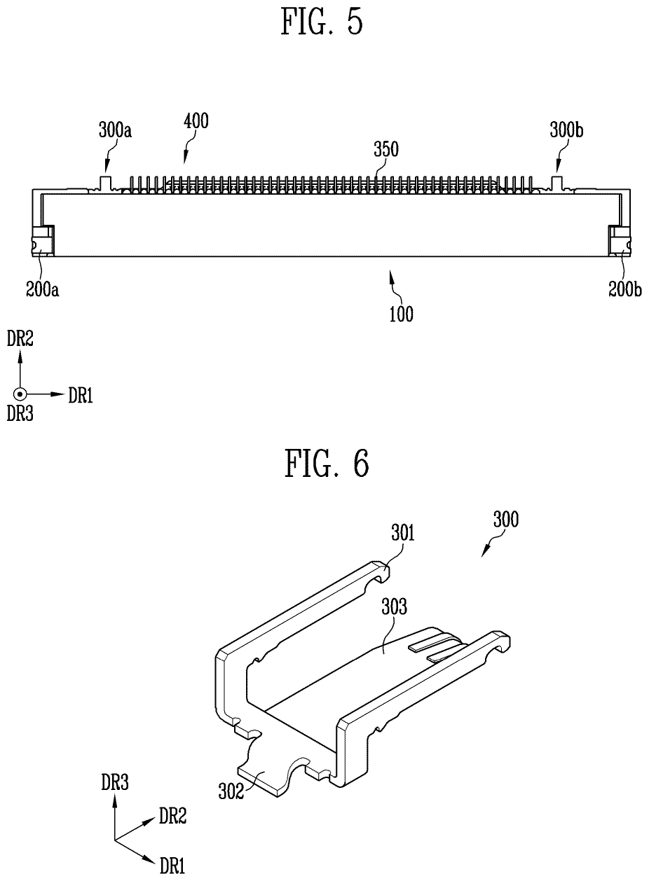

FIG. 3 is a perspective view of a connector according to an embodiment. FIG. 4 is an exploded perspective view of a connector according to an embodiment. FIG. 5 is a rear view of a connector according to an embodiment.

Referring to FIGS. 3 to 5, the connector CN may be used to electrically connect the flexible cable FC and the circuit board. The connector CN may include a case 100 for receiving (e.g., accommodating) the flexible cable FC. The case 100 may be coupled with an actuator 400. Pins 300 and 350 for electrical connection between the flexible cable FC and the circuit board may be coupled to the case 100.

The pins 300 and 350 may include first pins (e.g., power pins 300) and second pins (e.g., signal pins 350). A detailed description of the first pin 300 and the second pin 350 is described below with reference to FIGS. 6 to 11.

In an embodiment, the connector CN may include fix portions 200a and 200b for fixing the case 100 to the circuit board. The fix portions 200a and 200b may include a first fix portion 200a positioned at one end of the case 100 and a second fix portion 200b positioned at another end of the case 100. The first fix portion 200a and the second fix portion 200b may be mounted on the circuit board to fix the case 100 to the circuit board.

The actuator 400 may be rotatably coupled to the case 100. For example, the actuator 400 may be opened to an open position so that the flexible cable FC may be inserted therein. Then connector CN may then move to a closed position applying pressure to the inserted flexible cable FC to fix the flexible cable FC. The actuator 400 may have grooves, and the pins 300 and 350 may be received in the grooves.

The pins 300 and 350 may be spaced apart from each other in a first direction DR1. The first pins 300 may be positioned on an outer side of the connector CN. For example, the first pins 300 may include a first power terminal 300a and a second power terminal 300b spaced apart from each other. The first power terminal 300a may be positioned on an outer side of one side of the connector CN, and the second power terminal 300b may be positioned on an outer side of another side of the connector CN. The first power terminal 300a and the second power terminal 300b may be spaced apart with the second pins 350 therebetween.

The second pins 350 may be disposed at a center of the connector CN. The second pins 350 may be positioned between the first pins 300, which are spaced apart from each other. The second pins 350 may be positioned between the first power terminal 300a and the second power terminal 300b, which are spaced apart from each other.

The pins 300 and 350 may electrically connect the flexible cable FC and the circuit board. The pins 300 and 350 may be connected to the flexible cable FC inserted into the actuator 400 to be electrically connected to the flexible cable FC. The pins 300 and 350 may be mounted on the circuit board from outside of the actuator 400 to be electrically connected to the circuit board. The pins 300 and 350 may be electrically connected to the flexible cable FC inserted into the actuator 400 in a state in which the pins 300 and 350 are mounted on the circuit board to electrically connect the flexible cable FC and the circuit board. The pins 300 and 350 may be mounted on the circuit board by using surface mount technology. The pins 300 and 350 may be formed of a conductive material.

The first pins 300 may have a volume greater than that of the second pins 350 to have a greater allowable current than that of the second pins 350. For example, the first pins 300 may be implemented (or configured) to apply a current greater than that of a current applied by each of the second pins 350. For example, the first pins 300 may apply a current higher than that of each of the second pins 350. The second pins 350 may apply a current lower than that of the first pins 300. For example, the first pins 300 may be implemented to apply a current in a range of about 7 A to about 10 A, and the second pins 350 may apply a current of about 0.5 A. In an embodiment, the first pins 300 of the connector CN may apply (or transmit) power, and the second pins 350 may apply (or transmit) a signal. However, a purpose or a function of the pins 300 and 350 is not limited thereto. As described above, because the connector CN includes the first pins 300 having an allowable current greater than that of the second pins 350, an allowable current of the connector CN may be increased. Accordingly, the connector CN may reduce or mitigate a heat generation problem due to high current application, and because the entire allowable current may be increased without increasing the number of pins, a size of the connector CN may be reduced or minimized. Therefore, the connector CN may be implemented (or configured) to apply a relatively high current while reducing or minimizing the size thereof by including the first pins 300, thereby further improving performance of an electronic device and facilitating miniaturization thereof.

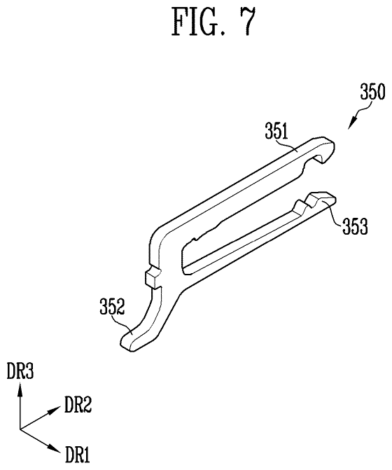

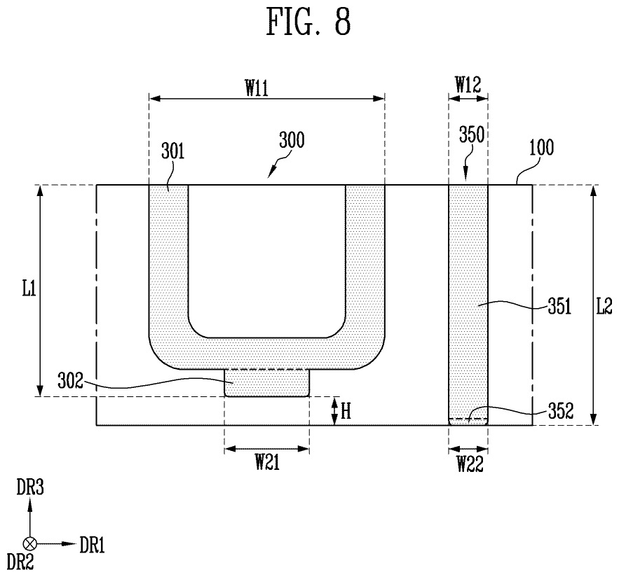

FIG. 6 is a perspective view of a first pin according to an embodiment. FIG. 7 is a perspective view of a second pin according to an embodiment. FIGS. 8 to 11 are side views of a first pin and a second pin according to an embodiment.

Referring to FIGS. 6 to 11, the first pin 300 and the second pin 350 may be coupled to the case 100. The first pin 300 may include a first coupling portion 301, a first contact portion 302, and/or a first connection portion 303.

The first coupling portion 301 may be an area coupled to the case 100. The first coupling portion 301 may include a support portion and an extension portion extending from the support portion. The support portion may be disposed in a horizontal direction (e.g. the first direction DR1).

The extension portion may pass through the actuator 400 and may be coupled to an interior of the case 100. For example, a portion of the extension portion may be inserted into the actuator 400 and may be fixed to the actuator 400.

The extension portion may include a first vertical extension portion extending in a vertical direction (e.g., a third direction DR3) from one end of the support portion and a second vertical extension portion extending in the vertical direction (e.g., the third direction DR3) from another end of the support portion. The first vertical extension portion and the second vertical extension portion may be spaced apart from each other in the first direction DR1.

The extension portion may further include a first horizontal extension portion extending in a second direction DR2 from an end of the first vertical extension portion and a second horizontal extension portion extending in the second direction DR2 from an end of the second vertical extension portion. The first horizontal extension portion and the second horizontal extension portion may be spaced apart from each other in the first direction DR1.

The first contact portion 302 may protrude from the first coupling portion 301. For example, the first contact portion 302 may protrude in a direction opposite to the second direction DR2 from the support portion of the first coupling portion 301 but is not limited thereto. The first contact portion 302 may be mounted on the circuit board. For example, the first contact portion 302 may be soldered to the surface of the circuit board by using surface mounted technology (SMT) but is not limited thereto. The first pin 300 may be mounted on the circuit board through the first contact portion 302 to be electrically connected to the circuit board.

The first connection portion 303 may protrude from the first coupling portion 301. For example, the first contact portion 302 may protrude in the second direction DR2 from the support portion of the first coupling portion 301 but is not limited thereto. The first connection portion 303 may be electrically connected to the flexible cable FC. For example, the first connection portion 303 may be electrically connected to the flexible cable FC inserted into the case 100. In an embodiment, the first coupling portion 301, the first contact portion 302, and/or the first connection portion 303 may be formed integrally but is not limited thereto.

The second pin 350 may include a second coupling portion 351, a second contact portion 352, and/or a second connection portion 353.

The second coupling portion 351 may be an area coupled to the case 100. The second coupling portion 351 may include a support portion and an extension portion extending from the support portion. The extension portion may pass through the actuator 400 and may be coupled into the case 100. For example, a portion of the extension portion may be inserted into the actuator 400 and may be fixed to the actuator 400.

The extension portion may include a vertical extension portion extending in the vertical direction (e.g., the third direction DR3) from an end of the support portion and a horizontal extension portion extending in the horizontal direction (e.g., the second direction DR2) from an end of the vertical extension portion.

The second contact portion 352 may protrude from the second coupling portion 351. For example, the second contact portion 352 may protrude in the direction opposite to the second direction DR2 from the support portion of the second coupling portion 351 but is not limited thereto. The second contact portion 352 may be mounted on the circuit board. For example, the second contact portion 352 may be soldered to the surface of the circuit board by using surface mounted technology (SMT) but is not limited thereto. The second pin 350 may be mounted on the circuit board via the second contact portion 352 to be electrically connected to the circuit board.

The second connection portion 353 may protrude from the second coupling portion 351. For example, the second contact portion 352 may protrude in the second direction DR2 from the support portion of the second coupling portion 351 but is not limited thereto. The second connection portion 353 may be electrically connected to the flexible cable FC. For example, the second connection portion 353 may be electrically connected to the flexible cable FC inserted into the case 100. In an embodiment, the second coupling portion 351, the second contact portion 352, and/or the second connection portion 353 may be formed integrally but is not limited thereto.

In an embodiment, a width W11 of the first coupling portion 301 in the first direction DR1 may be different from a width W12 of the second coupling portion 351 in the first direction DR1. The width W11 of the first coupling portion 301 in the first direction DR1 may be greater than the width W12 of the second coupling portion 351 in the first direction DR1.

A width W21 of the first contact portion 302 in the first direction DR1 may be different from a width W22 of the second contact portion 352 in the first direction DR1. The width W21 of the first contact portion 302 in the first direction DR1 may be greater than the width W22 of the second contact portion 352 in the first direction DR1.

A width WP1 of a first pad P1 of the circuit board in the first direction DR1 on which the first contact portion 302 is mounted may be different from a width WP2 of a second pad P2 of the circuit board in the first direction DR1 on which the second contact portion 352 is mounted. The width WP1 of the first pad P1 in the first direction DR1 may be greater than the width WP2 of the second pad P2 in the first direction DR1. In such an embodiment, a thickness (or a lead amount) a first solder SD1 in the third direction DR3 between the first contact portion 302 and the first pad P1 may be different from a thickness (or a lead amount) of a second solder SD2 in the third direction DR3 between the second contact portion 352 and the second pad P2. The thickness (or the lead amount) of the first solder SD1 in the third direction DR3 may be greater than the thickness (or the lead amount) of the second solder SD2 in the third direction DR3.

Referring to FIG. 8, in the connector CN, according to an embodiment, a height in the third direction DR3 of the first pin 300 (or of the first contact portion 302) may be different from a height in the third direction DR3 of the second pin 350 (or of the second contact portion 352) to prevent a phenomenon in which the connector CN is bent due to a thickness step difference (or a lead amount difference) between the first solder SD1 and the second solder SD2. For example, the height of the first pin 300 (or of the first contact portion 302) in the third direction DR3 may be higher than the height of the second pin 350 (or of the second contact portion 352) in the third direction DR3.

A length L1 of the first pin 300 in the third direction DR3 may be different from a length L2 of the second pin 350 in the third direction DR3. For example, the length L1 of the first pin 300 in the third direction DR3 may be shorter than the length L2 of the second pin 350 in the third direction DR3. In such an embodiment, a distance between the first pin 300 (or the first contact portion 302) and the first pad P1 in the third direction DR3 may be greater than a distance between the second pin 350 (or the second contact portion 352) and the second pad P2 in the third direction DR3.

In an embodiment, a height difference H between the first pin 300 (or the first contact portion 302) and the second pin 350 (or the second contact portion 352) in the third direction DR3 (or a length difference between the first pin 300 and the second pin 350 in the third direction DR3) may be about 80 μm or less. For example, the height difference H between the first pin 300 and the second pin 350 in the third direction DR3 (or the length difference between the first pin 300 and the second pin 350 in the third direction DR3) may be in a range of about 30 μm to about 50 μm. When the height difference H between the first pin 300 and the second pin 350 in the third direction DR3 (or the length difference between the first pin 300 and the second pin 350 in the third direction DR3) is excessively small, the connector CN may be bent or a lifting phenomenon may occur at an outer portion of the connector CN where the first pin 300 is positioned due to a thickness step difference between the first solder SD1 and the second solder SD2. When the height difference H between the first pin 300 (or the first contact portion 302) and the second pin 350 in the third direction DR3 (or the second contact portion 352) (or the length difference between the first pin 300 and the second pin 350 in the third direction DR3) is excessively large, contact failure of the first pin 300 (or of the first contact portion 302) may occur. The height difference H between the first pin 300 and the second pin 350 in the third direction DR3 (or the length difference between the first pin 300 and the second pin 350 in the third direction DR3) may be variously changed in consideration of a size of the pads P1 and P2, the thickness step difference of the solders SD1 and SD2, and the like.

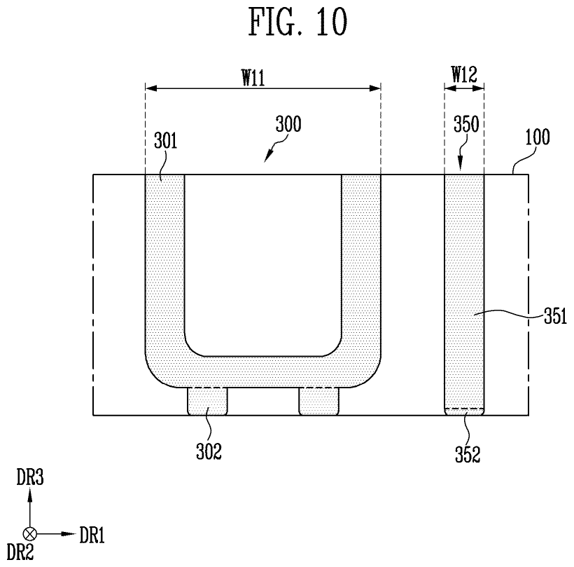

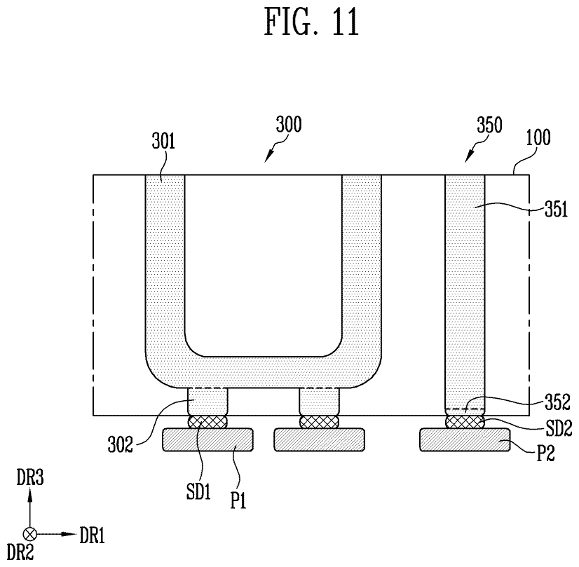

Referring to FIGS. 10 and 11, to prevent the phenomenon in which the connector CN is bent due to the lead amount difference between the solders SD1 and SD2 described above, the number of first contact portions 302 may be different from the number of second contact portions 352. For example, the number of first contact portions 302 may be greater than the number of second contact portions 352. For example, a plurality of the first contact portions 302 may be provided, and ones of the of first contact portions 302 may be spaced apart from each other. The first contact portions 302 may be spaced apart in the first direction DR1. As described above, when the plurality of first contact portion 302 are provided, the thickness step difference (or the lead amount difference) of the first solder SD1 and the second solder SD2 in the third direction DR3 may be reduced or minimized, and a phenomenon in which the first solder SD1 is clumped may be alleviated. In the drawings, an embodiment in which two first contact portions 302 are provided and one second contact portion 352 is configured is provided, but the present disclosure is not limited thereto. The number of first contact portions 302 and second contact portions 352 may be variously changed within a range that may reduce or minimize the lead amount difference between the first solder SD1 and the second solder SD2.

The number of first pads P1 of the circuit board on which the first contact portion 302 is mounted may be different from the number of second pads P2 of the circuit board on which the second contact portion 352 is mounted. The number of first pads P1 may be greater than the number of second pads P2. In the drawings, an embodiment in which two first pads P1 are provided and one second pad P2 is provided is shown, but the present disclosure is not limited thereto. The number of first pads P1 and second pads P2 may be variously changed within a range that may reduce or minimize the lead amount difference between the first solder SD1 and the second solder SD2.

The area (e.g., contact area or surface area) of the first contact portion 302 may be different from the area of the second contact portion 352. For example, the area of the first contact portion 302 may be greater than the area of the second contact portion 352. The area of the first pad P1 on which the first contact portion 302 is mounted may be different from the area of the second pad P2 on which the second contact portion 352 is mounted. The area of the first pad P1 may be greater than the area of the second pad P2.

FIG. 12 is a plan view of a display panel according to an embodiment.

Referring to FIG. 12, the display panel DP may have a display area DA and a non-display area NDA. The display panel DP displays an image at (or from) the display area DA. The non-display area NDA is disposed around the display area DA.

The display panel DP may include a substrate SUB, sub-pixels SP, and/or display pads PD.

The sub-pixels SP are disposed in the display area DA on the substrate SUB. The sub-pixels SP may be arranged in a matrix form along the first direction DR1 and the second direction DR2 crossing (e.g., intersecting) the first direction DR1. However, embodiments are not limited thereto. For example, the sub-pixels SP may be arranged in a zigzag form along the first direction DR1 and the second direction DR2. For example, the sub-pixels SP may be disposed in a PenTile® (a registered trademark of Samsung Display Co., Ltd.) form. The first direction DR1 may be a row direction, and the second direction DR2 may be a column direction. Two or more of the sub-pixels SP may configure one pixel PXL.

A component for controlling the sub-pixels SP may be disposed in the non-display area NDA on the substrate SUB. For example, lines connected to the sub-pixels SP, such as gate lines and data lines, may be disposed in the non-display area NDA.

The display pads PD are disposed in the non-display area NDA on the substrate SUB. The display pads PD may be electrically connected to the sub-pixels SP through the lines. For example, the display pads PD may be connected to the sub-pixels SP through the data lines.

The display pads PD may interface the display panel DP to other components of the display device DD. In an embodiment, voltages and signals for operation of components included in the display panel DP may be provided from a driver integrated circuit through the display pads PD. For example, the data lines may be connected to the driver integrated circuit through the display pads PD. For example, power voltages may be received from the driver integrated circuit through the display pads PD.

In an embodiment, the display area DA may have various shapes. The display area DA may have a closed loop shape including sides having a straight line shape and/or a curved line shape. For example, the display area DA may have shapes, such as a polygon, a circle, a semicircle, and an ellipse.

In an embodiment, the display panel DP may have a flat display surface. In another embodiment, the display panel DP may have at least a partially rounded (or curved) display surface. In an embodiment, the display panel DP may be bendable, foldable, or rollable. In such embodiments, the display panel DP and/or the substrate SUB may include materials having a flexible property.

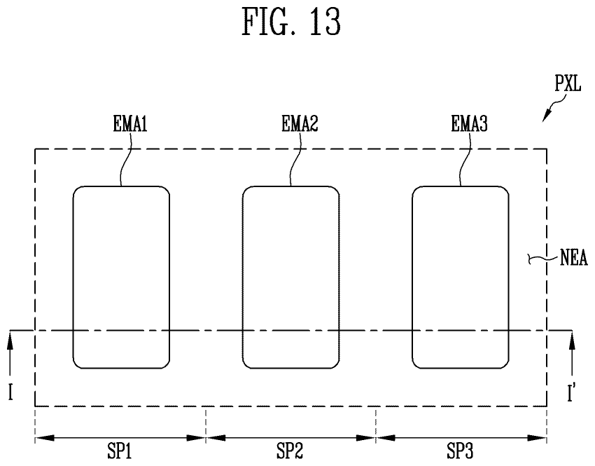

FIG. 13 is a plan view of a sub-pixel according to an embodiment.

Referring to FIG. 13, the pixel PXL may include first to third sub-pixels SP1 to SP3 arranged in the first direction DR1.

The first sub-pixel SP1 may have a first emission area EMA1 and a non-emission area NEA around the first emission area EMA1. The second sub-pixel SP2 may have a second emission area EMA2 and a non-emission area NEA around the second emission area EMA2. The third sub-pixel SP3 may have a third emission area EMA3 and a non-emission area NEA around the third emission area EMA3.

The first emission area EMA1 may be an area at where light is emitted from a first light emitting layer EML1 of the first sub-pixel SP1. The second emission area EMA2 may be an area at where light is emitted from a second light emitting layer EML2 of the second sub-pixel SP2. The third emission area EMA3 may be an area at where light is emitted from a third light emitting layer EML3 of the third sub-pixel SP3.

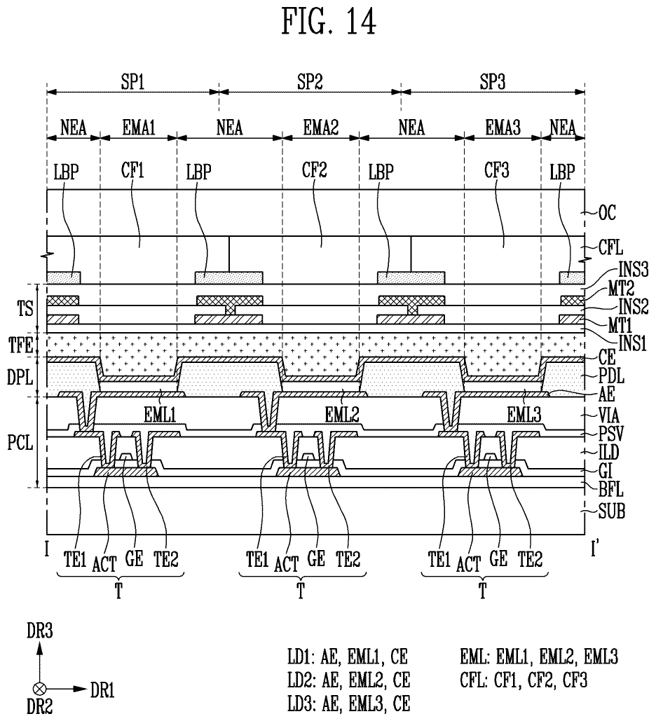

FIG. 14 is a cross-sectional view taken along the line I-I′ in FIG. 13.

Referring to FIG. 14, each of the first to third sub-pixels SP1 to SP3 may have the emission area EMA, and the non-emission area NEA may be positioned between the emission areas EMA1 to EMA3 of the first to third sub-pixels SP1 to SP3, respectively.

Each of the first to third sub-pixels SP1 to SP3 may include a pixel circuit layer PCL, a display element layer DPL, and/or a thin film encapsulation layer TFE sequentially disposed on the substrate SUB.

The substrate SUB may form a base surface. The substrate SUB may include a transparent insulating material and, thus, may transmit light. The substrate SUB may be a rigid substrate or a flexible substrate. The rigid substrate may be, for example, one of a glass substrate, a quartz substrate, a glass ceramic substrate, and a crystalline glass substrate. The flexible substrate may be one of a film substrate and a plastic substrate including a polymer organic material. For example, the flexible substrate may include at least one of polystyrene, polyvinyl alcohol, polymethyl methacrylate, polyethersulfone, polyacrylate, polyetherimide, polyethylene naphthalate, polyethylene terephthalate, polyphenylene sulfide, polyarylate, polyimide, polycarbonate, triacetate cellulose, and cellulose acetate propionate but is not limited thereto.

The pixel circuit layer PCL may include a pixel circuit provided on the substrate SUB. The pixel circuit layer PCL may include a sensor circuit provided on the substrate SUB.

The pixel circuit layer PCL may include a buffer layer BFL, a gate insulating layer GI, an interlayer insulating layer ILD, a passivation layer PSV, and/or a via layer VIA sequentially stacked on the substrate SUB along the third direction DR3.

The buffer layer BFL may be an inorganic insulating layer including an inorganic material. The buffer layer BFL may include at least one of a metal oxide, such as silicon nitride (SiNₓ), silicon oxide (SiOₓ), silicon oxynitride (SiOₓN_{y}), and aluminum oxide (AlOₓ). The buffer layer BFL may be provided as a single layer but may also be provided as multiple layers including two or more layers. When the buffer layer BFL is provided as multiple layers, each layer may be formed of the same material or may be formed of different materials. In some embodiment, the buffer layer BFL may be omitted according to a material, a process condition, and the like of the substrate SUB.

A transistor T may be disposed on the buffer layer BFL. The transistor T may include an active pattern ACT, a gate electrode GE, a first transistor electrode TE1, and/or a second transistor electrode TE2.

The active pattern ACT may be disposed on the buffer layer BFL. The active pattern ACT may include a polysilicon semiconductor. For example, the active pattern ACT may be formed through a low-temperature polysilicon process. However, the present disclosure is not limited thereto, and the active pattern ACT may be formed of an oxide semiconductor, a metal oxide semiconductor, or the like.

Each active pattern ACT may each have a channel area, a first contact area connected to (or extending from) one end of the channel area, and a second contact area connected to (or extending from) another end of the channel area. The channel area, the first contact area, and the second contact area may be formed of a semiconductor layer that is not doped with an impurity or is doped with an impurity. For example, the first contact area and the second contact area may be formed of a semiconductor layer doped with an impurity, and the channel area may be formed of a semiconductor layer that is not doped with an impurity. As an impurity, for example, a p-type impurity may be used, but is not limited thereto. One of the first and second contact areas may be a source area and the other may be a drain area.

The gate insulating layer GI may be disposed on the active pattern ACT. The gate insulating layer GI may be an inorganic layer (or an inorganic insulating layer) including an inorganic material. For example, the gate insulating layer GI may include at least one of a metal oxide, such as silicon nitride (SiNₓ), silicon oxide (SiOₓ), silicon oxynitride (SiOₓN_{y}), and aluminum oxide (AlOₓ). However, a material of the gate insulating layer GI is not limited to that described above. According to an embodiment, the gate insulating layer GI may be formed of an organic layer (or organic insulating layer) including an organic material. The gate insulating layer GI may be provided as a single layer but may also be provided as multiple layers including two or more layers.

The gate electrode GE may be disposed on the gate insulating layer GI. The gate electrode GE may overlap the channel area of the active pattern ACT. The gate electrode GE may be formed as a single layer using only one or a mixture of materials selected from a group consisting of copper (Cu), molybdenum (Mo), tungsten (W), aluminum neodymium (AlNd), titanium (Ti), aluminum (Al), silver (Ag), and an alloy thereof or may be formed as a double layer or a multilayer structure of molybdenum (Mo), titanium (Ti), copper (Cu), aluminum (Al), or silver (Ag), which is a low-resistance material to reduce a line resistance.

The interlayer insulating layer ILD may be disposed on the gate electrode GE. The interlayer insulating layer ILD may include the same material as the gate insulating layer GI or may include one or more materials selected from a material describing above as a configuration material of the gate insulating layer GI.

The first transistor electrode TE1 and the second transistor electrode TE2 may be disposed on the interlayer insulating layer ILD. The first transistor electrode TE1 of the transistor T may contact the first contact area of the active pattern ACT through a contact hole (e.g., a contact opening) passing through the interlayer insulating layer ILD and the gate insulating layer GI. When the first contact area is the source area, the first transistor electrode TE1 may be a first source electrode.

The second transistor electrode TE2 of the transistor T may contact the second contact area of the other end of the active pattern ACT through a contact hole (e.g., a contact opening) passing through the interlayer insulating layer ILD and the gate insulating layer GI. When the second contact area is the drain area, the second transistor electrode TE2 may be a second drain electrode.

Each of the first transistor electrode TE1 and the second transistor electrode TE2 may include the same material as the gate electrode GE or may include one or more materials selected from materials described above as a configuration material of the gate electrode GE.

The passivation layer PSV may be disposed on the first transistor electrode TE1 and the second transistor electrodes TE2. The passivation layer PSV (e.g., a protective layer) may be an inorganic layer (or an inorganic insulating layer) including an inorganic material or an organic layer (or an organic insulating layer) including an organic material. The inorganic layer may include, for example, at least one of a metal oxide, such as silicon oxide (SiOₓ), silicon nitride (SiNₓ), silicon oxynitride (SiOₓN_{y}), and aluminum oxide (AlOₓ). The organic layer may include, for example, at least one of an acrylic resin (polyacrylates resin), an epoxy resin, a phenolic resin, polyamides resin, polyimides resin, unsaturated polyesters resin, polyphenylene ethers resin, polyphenylene sulfides resin, and a benzocyclobutene resin.

According to an embodiment, the passivation layer PSV may include the same material as the interlayer insulating layer ILD but is not limited thereto. The passivation layer PSV may be provided as a single layer but may also be provided as multiple layers including two or more layers.

The via layer VIA may be disposed on the passivation layer PSV. The via layer VIA may include the same material as the passivation layer PSV or may include one or more materials selected from materials described above as a configuration material of the passivation layer PSV. In an embodiment, the via layer VIA may be an organic layer formed of an organic material.

The display element layer DPL may be disposed on the pixel circuit layer PCL. The display element layer DPL may include a light emitting element LD that emits (e.g., is configured to emit) light. The first to third sub-pixels SP1 to SP3 may include first to third light emitting elements LD1 to LD3, respectively.

The first light emitting element LD1 may include an anode electrode AE, the first light emitting layer EML1, and a cathode electrode CE. The second light emitting element LD2 may include an anode electrode AE, the second light emitting layer EML2, and the cathode electrode CE. The third light emitting element LD3 may include an anode electrode AE, the third light emitting layer EML3, and the cathode electrode CE. For example, the first to third light emitting elements LD1 to LD3 may be a front surface light emitting type organic light emitting element.

The anode electrode AE of each sub-pixel SP may be disposed in the respective emission area EMA and may be spaced apart from each other. The anode electrode AE of each sub-pixel SP may be electrically connected to the first transistor electrode TE1 of the transistor T of each respective sub-pixel SP through a contact hole (e.g., a contact opening) passing through the via layer VIA and the passivation layer PSV.

A bank PDL may be disposed on the anode electrode AE. The bank PDL may define (or partition) the emission area EMA of each sub-pixel SP. The bank PDL may have an opening partially exposing the anode electrode AE of each sub-pixel SP.

The bank PDL may be an organic insulating layer formed of an organic material. The organic material may include an acryl resin, an epoxy resin, a phenolic resin, a polyamide resin, a polyimide resin, and the like.

According to an embodiment, the bank PDL may include a light absorbing material or may be coated with a light absorbing material to absorb light incident from the outside. For example, the bank PDL may include a carbon-based black pigment. However, the present disclosure is not limited thereto, and the bank PDL may include an opaque metal material, such as chromium (Cr), molybdenum (Mo), an alloy of molybdenum (Mo) and titanium (Ti) (MoTi), tungsten (W), vanadium (V), niobium (Nb), tantalum (Ta), manganese (Mn), cobalt (Co), or nickel (Ni).

A light emitting layer EML of each sub-pixel SP may be disposed on the anode electrode AE exposed by the bank PDL. The cathode electrode CE may be disposed on the light emitting layer EML. The cathode electrode CE may be disposed over the entirety of the first to third sub-pixels SP1 to SP3. For example, the cathode electrode CE may be provided as a common electrode but is not limited thereto.

The cathode electrode CE may be formed of a metal layer of Ag(silver), Mg(magnesium), Al(aluminum), Pt(platinum), Pd(palladium), Au(gold), Ni(nickel), Nd(neodymium), Ir(iridium), Cr(chromium), an alloy thereof, and the like, and/or a transparent conductive layer of indium tin oxide (ITO), indium zinc oxide (IZO), zinc oxide (ZnO), indium tin zinc oxide (ITZO), and the like. According to an embodiment, the cathode electrode CE may be formed as multiple layers, such as two or more layers including a metal thin layer, for example, three layers including ITO/Ag/ITO.

The thin film encapsulation layer TFE may be disposed on the display element layer DPL. The thin film encapsulation layer TFE may have a single layer structure or a multiple layer structure. The thin film encapsulation layer TFE may include an insulating layer covering the light emitting element LD. The thin film encapsulation layer TFE may include at least one inorganic layer and at least one organic layer. For example, the thin film encapsulation layer TFE may have a structure in which an inorganic layer and an organic layer are alternately stacked on each other. For example, the thin film encapsulation layer TFE may include a first inorganic layer, an organic layer disposed on the first inorganic layer, and a second inorganic layer disposed on the organic layer.

A sensing layer TS may be disposed on the thin film encapsulation layer TFE. The sensing layer TS may include a first insulating layer INS1, a first conductive layer MT1, a second insulating layer INS2, a second conductive layer MT2, and/or a third insulating layer INS3.

The first insulating layer INS1 may be disposed on the thin film encapsulation layer TFE. The first insulating layer INS1 may be an inorganic insulating layer including an inorganic material. The inorganic insulating layer may include an inorganic insulating material, such as silicon oxide (SiOₓ), silicon nitride (SiNₓ), silicon oxynitride (SiOₓN_{y}), aluminum oxide (AlₓO_{y}), titanium oxide (TiOₓ), tantalum oxide (TaₓO_{y}), hafnium oxide (HfOₓ), or zinc oxide (ZnOₓ). In some embodiments, the first insulating layer INS1 may be omitted or may be configured as the uppermost layer of the thin film encapsulation layer TFE.

The first conductive layer MT1 may be disposed on the first insulating layer INS1. The first conductive layer MT1 may be partially opened (e.g., may have openings therein) so as not to overlap the light emitting element LD of each sub-pixel SP. For example, the first conductive layer MT1 may be disposed to overlap the non-emission area NEA around the emission area EMA.

The first conductive layer MT1 may include a metal layer or a transparent conductive layer. For example, the metal layer may include molybdenum, titanium, copper, aluminum, and an alloy thereof. The transparent conductive layer may include one of indium tin oxide (ITO), indium zinc oxide (IZO), zinc oxide (ZnO), indium tin zinc oxide (ITZO), PEDOT, and a metal nanowire but is not limited thereto. The first conductive layer MT1 may form a connection electrode connecting sensing electrodes.

The second insulating layer INS2 may be disposed on the first conductive layer MT1. The second insulating layer INS2 may include the same material as the first insulating layer INS1 described above or may include one or more materials selected from the materials described above as the configuration material of the first insulating layer INS1.

The second conductive layer MT2 may be disposed on the second insulating layer INS2. The second conductive layer MT2 may be partially opened (e.g., may have openings) so as not to overlap the light emitting element LD of each sub-pixel SP. For example, the second conductive layer MT2 may be disposed to overlap the non-emission area NEA around the emission area EMA.

The second conductive layer MT2 may include the same material as the first conductive layer MT1 described above or may include one or more materials selected from the materials described above as the configuration material of the first conductive layer MT1.

The second conductive layer MT2 may be electrically connected to the first conductive layer MT1 through a contact hole (e.g., a contact opening) passing through the second insulating layer INS2. The second conductive layer MT2 may form sensing electrodes.

The third insulating layer INS3 may be disposed on the second conductive layer MT2. The third insulating layer INS3 may be an organic insulating layer including an organic material. However, the present disclosure is not limited thereto, and according to an embodiment, the third insulating layer INS3 may be formed of an inorganic layer or may have a structure in which an organic layer and an inorganic layer are alternately stacked on each other.

A light blocking layer LBP may be disposed on the display element layer DPL, the thin film encapsulation layer TFE, and/or the sensing layer TS. The light blocking layer LBP may have an opening overlapping the light emitting element LD. For example, the light blocking layer LBP may be disposed to overlap the non-emission area NEA around the emission area EMA.

The light blocking layer LBP may include a light blocking material to prevent light leakage and color mixing defects. For example, the light blocking layer LBP may include a black matrix but is not limited thereto. According to an embodiment, the light blocking layer LBP may include carbon black (CB) and/or titan black (TiBK).

A color filter layer CFL may be disposed on the light blocking layer LBP. The color filter layer CFL may include color filters CF1 to CF3 that match a color of each sub-pixel SP. The color filters CF1 to CF3 matching the color of the respective first to third sub-pixels SP1 to SP3 allow for a full color of image to be displayed.

The color filter layer CFL may include a first color filter CF1 disposed in the first sub-pixel SP1 to selectively transmit light emitted from the first sub-pixel SP1, a second color filter CF2 disposed in the second sub-pixel SP2 to selectively transmit light emitted from the second sub-pixel SP2, and a third color filter CF3 disposed in the third sub-pixel SP3 to selectively transmit light emitted from the third sub-pixel SP3.

In an embodiment, the first color filter CF1, the second color filter CF2, and the third color filter CF3 may be a red color filter, a green color filter, and a blue color filter, respectively, but are not limited thereto.

The first color filter CF1 may include a color filter material that selectively transmits light of a first color (e.g., red). For example, when the first sub-pixel SP1 is a red sub-pixel, the first color filter CF1 may include a red color filter material.

The second color filter CF2 may include a color filter material that selectively transmits light of a second color (e.g., green). For example, when the second sub-pixel SP2 is a green sub-pixel, the second color filter CF2 may include a green color filter material.

The third color filter CF3 may include a color filter material that selectively transmits light of a third color (e.g., blue). For example, when the third sub-pixel SP3 is a blue sub-pixel, the third color filter CF3 may include a blue color filter material.

An overcoat layer OC may be provided on the color filter layer CFL. The overcoat layer OC may include various materials suitable for protecting lower layers from a foreign substance, such as dust or moisture. For example, the overcoat layer OC may include at least one of an inorganic insulating layer and an organic insulating layer. For example, the overcoat layer OC may include epoxy, but embodiments are not limited thereto.

A display device according to an embodiment is applicable to various types of electronic devices. In an embodiment, an electronic device includes the above-described display device and may further include other modules or devices having additional functions in addition to the display device.

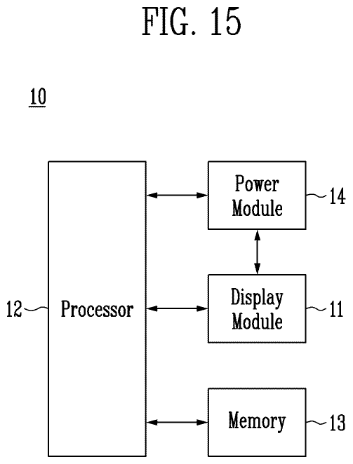

FIG. 15 is a block diagram describing an electronic device according to an embodiment. Referring to FIG. 15, the electronic device 10 may include a display module 11, a processor 12, a memory 13, and a power module 14.

The processor 12 may include at least one of a central processing unit (CPU), an application processor (AP), a graphic processing unit (GPU), a communication processor (CP), an image signal processor (ISP), and a controller.

The memory 13 may store data and/or information used to operate the processor 12 or the display module 11. When the processor 12 executes an application stored in the memory 13, image data signals and/or input control signals may be transferred to the display module 11. The display module 11 may process the provided (e.g., received) signals and output image information on a display screen.

The power module 14 may include a power supply module, such as a power adapter or a battery device, and a power conversion module. The power conversion module converts power supplied by the power supply module and generates power to operate the electronic device 10.

At least one of the above-described components of the electronic device 10 may be included in the display device according to embodiments as described above. In addition, in terms of functionality, some of the individual modules included in one module may be included in the display device and others may be provided separately from the display device. For example, the display module 11 is included in the display device, whereas the processor 12, the memory 13, and the power module 14 are not included in the display device and are instead provided separately in the electronic device 10.

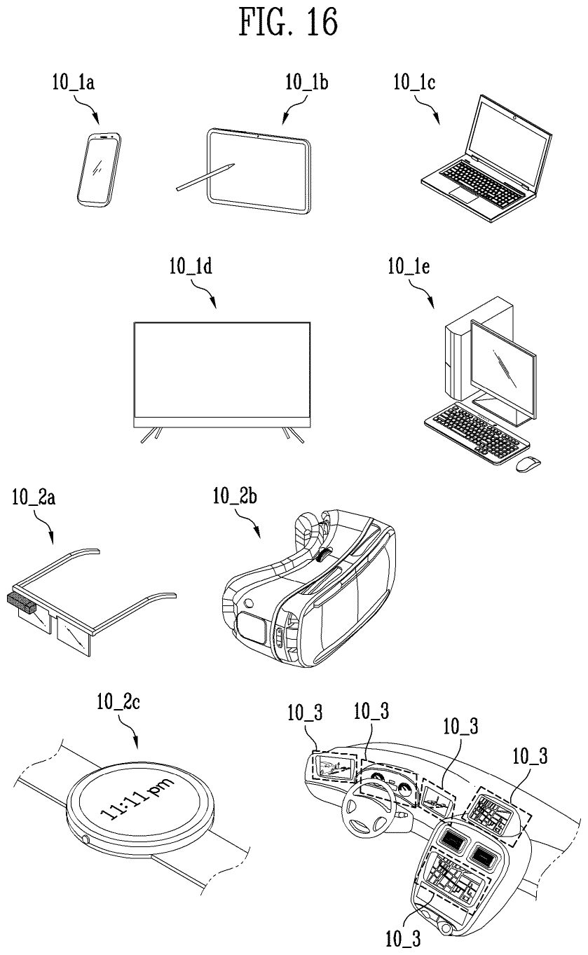

FIG. 16 shows schematic views of various embodiments of an electronic device.

Referring to FIG. 16, various types of electronic devices to which embodiments of a display device are applied may include an electronic device that displays images, such as a smartphone 10_1a, a tablet PC 10_1b, a laptop computer 10_1c, a television (TV) 10_1d, a desktop monitor 10_1e, a wearable electronic device including a display module, such as smart glasses 10_2a, a head-mounted display (HMD) 10_2b, and a smart watch 10_2c, and an automotive electronic device 10_3 including a display module, such as a center information display (CID) disposed at the instrument cluster, the center fascia, and the dashboard of a vehicle, and a room mirror display.

Although embodiments and application examples according to the present disclosure are described herein, other embodiments and variations may be derived from the above description. Therefore, the spirit of the present disclosure is not limited to these embodiments, and extends to the claims set forth below, various obvious modifications, and equivalents thereof.

What is claimed is:

1. A connector comprising:
a case;
first pins, each of the first pins having a first coupling portion coupled to the case and a first contact portion protruding from the first coupling portion; and
second pins, each of the second pins having a second coupling portion coupled to the case and a second contact portion protruding from the second coupling portion,
wherein a height of the first contact portion is different from a height of the second contact portion.

2. The connector according to claim 1, wherein the height of the first contact portion is higher than the height of the second contact portion.

3. The connector according to claim 1, wherein a height difference between the first contact portion and the second contact portion is 80 μm or less.

4. The connector according to claim 1, wherein a width of the first contact portion is greater than a width of the second contact portion.

5. The connector according to claim 1, wherein a width of the first coupling portion is greater than a width of the second coupling portion.

6. The connector according to claim 1, wherein the second pins are between adjacent ones of the first pins.

7. The connector according to claim 1, wherein the first pins are at an outer side of the connector.

8. The connector according to claim 1, wherein the second pins are at a center of the connector.

9. A connector comprising:
a case;
first pins, each of the first pins having a first coupling portion coupled to the case and a first contact portion protruding from the first coupling portion; and
second pins, each of the second pins having a second coupling portion coupled to the case and a second contact portion protruding from the second coupling portion,
wherein a number of the first contact portions is different from a number of the second contact portions.

10. The connector according to claim 9, wherein the number of the first contact portions is greater than the number of the second contact portions.

11. The connector according to claim 9, wherein an area of the first contact portion is greater than an area of the second contact portion.

12. The connector according to claim 9, wherein a width of the first coupling portion is greater than a width of the second coupling portion.

13. The connector according to claim 9, wherein the second pins are between adjacent ones of the first pins.

14. The connector according to claim 9, wherein the first pins are at outer side of the connector.

15. The connector according to claim 9, wherein the second pins are at a center of the connector.

16. An electronic device comprising:
a processor configured to provide input image data; and
a display device to display an image based on the input image data, the display device comprising:
a display panel;
a circuit board electrically connected to the display panel; and
a connector comprising a case, first pins, and second pins, the first pins and the second pins being electrically connected to the circuit board,
wherein each of the first pins has a first coupling portion coupled to the case and a first contact portion protruding from the first coupling portion,
wherein each of the second pins has a second coupling portion coupled to the case and a second contact portion protruding from the second coupling portion, and
wherein a height of the first contact portion is different from a height of the second contact portion.

17. The electronic device according to claim 16, wherein the height of the first contact portion is higher than the height of the second contact portion.

18. The electronic device according to claim 16, wherein the circuit board comprises:
a first pad electrically connected to the first contact portion; and
a second pad electrically connected to the second contact portion.

19. The electronic device according to claim 18, wherein a width of the first pad is greater than a width of the second pad.

20. The electronic device according to claim 19, wherein a distance between the first pad and the first contact portion is greater than a distance between the second pad and the second contact portion.
